(19) United States
(12) Patent Application Publication
(10) Pub. No.: US 2018/0015637 A1
(43) Pub. Date: Jan. 18, 2018

(54) METHOD OF MANUFACTURING CROP STRAW FIBER BOARD

(71) Applicant: SHANGHAI ZHENSEN WOOD-WORKING MACHINERY CO., LTD, Shanghai (CN)

(72) Inventors: Zhencai ZHANG, Shanghai (CN); Tao ZHANG, Shanghai (CN)

(73) Assignee: SHANGHAI ZHENSEN WOOD-WORKING MACHINERY CO., LTD, Shanghai (CN)

(21) Appl. No.: 15/536,111

(22) PCT Filed: Nov. 10, 2015
(86) PCT No.: PCT/CN2015/094237

§ 371 Date: Jun. 14, 2017

(30) Foreign Application Priority Data
Dec. 16, 2014 (CN) 201410774745.3

(51) Int. Cl. B27N 3/04; B27N 1/02; B27N 3/14; B27D 1/08

(52) U.S. Cl. CPC B27N 3/04; B27N 3/143; B27N 1/0245; B27D 1/08

(57) ABSTRACT

A method of manufacturing crop straw fiber board includes the following steps: (1) mashing and choosing the straws with the length of 10-40 mm and the moisture content of 20%-30% as raw materials; (2) sending the raw materials into a digester (5) to digest and soften the straws; (3) sending the raw materials into a defiberator (7) and grinding to obtain straw fibers; (4) sending the straw fibers into a liquid applying system to mix with the adhesive, then drying with hot wind; (5) paving the straw fibers, then pre-pressing to obtain a plate blank with the thickness of 30-180 mm; (6) sending the plate blank into No. 1 hot press (8) to dehydrate; (7) sending the plate blank to No. 2 hot press (9) to adhere the plate blank; (8) sending the plate blank to No. 3 cold press (10) to shape the plate blank; (9) trimming and sanding the plate blank to obtain the fiberboard. Any crop straws could be used for the method.

### RELATED APPLICATIONS

This application is a national stage entry of PCT Application No. PCT/CN2015/094237 filed on Nov. 10, 2015, which claims the benefit of Chinese Application No. 201410774745.3 filed on Dec. 16, 2014, each of which is incorporated herein by reference

### TECHNICAL FIELD

This invention relates to a method of manufacturing medium or high density fiber board, especially to a method of manufacturing high density fiber board using crop straws.

### BACKGROUND ART

In the current market, there is only technique of manufacturing wood fiber board. Such technique is not applicable when using straws as the raw materials. However, some board manufacturing processes using straws as the raw materials either add cement into the applied liquid to create cement board, or choose specific cotton straws or maize straws. In the first case, although straws are used as the raw materials, the cement board is heavy and rough and is not as good as medium or high density fiber board. In the second case, the applicable field is quite narrow and the productivity is very low. Consequently, the technology to manufacture medium or high density fiber board purely using straws as the raw materials is still blank.

### CONTENTS OF INVENTION

This invention relates to a method of manufacturing crop straw fiber board, wherein the method includes the following steps:
(1) Mashing the straws, and choosing the straws which have the length of 10 mm to 40 mm and moisture content of 20% to 30% as raw materials;
(2) Sending the raw materials into the digester to digest and soften the straw raw materials;
(3) Sending the raw materials into the defiberator, grinding the raw materials to obtain straw fibers;
(4) Sending the straw fibers into the liquid applying system to mix the straw fibers with adhesive, then drying the straw fibers with hot wind;
(5) Continuing paving the straw fibers, then pre-pressing the straw fibers to obtain a plate blank with thickness of 30 mm to 180 mm;
(6) Sending the plate blank into No. 1 hot press to dehydrate the plate blank by hot-pressing;
(7) Sending the plate blank sent from No. 1 hot press into No. 2 hot press to adhere the plate blank by hot-pressing;
(8) Sending the plate blank sent from No. 2 hot press into cold press to shape the plate blank by cold-pressing;
(9) Trimming and sanding the plate blank sent from the cold press to make the fiber board.

In said step (2) of softening the straw raw materials, horizontal digester is adopted. The digester is inclined to the ground with an included angel of 3 to 6°. The digester is injected with water to digest the raw materials, wherein the weight ratio of water to the straws is 1 to 1. The temperature of the steam in the digester is 80 to 160° C. The pressure in the digester is 3 to 6 kilograms/cm². The time that the raw materials use to pass through the digester is 10 to 20 minutes.

In said step (4) of sending the straw fibers into the liquid applying system, the straw fibers are pushed in the tube by steam force, while adhesive is sprayed. The weight ratio of the adhesive to the straw fibers is 12 to 100. The straw fibers obtained from drying with hot wind have moisture content of 12% to 18%.

In said step (6) of dehydrating by hot-pressing, the hot-pressing is conducted in a high temperature and medium pressure environment, wherein the temperature is 130 to 200° C., and the pressure is 110 to 150 kilograms/cm². The said dehydrating by hot-pressing lasts for 40 to 70 seconds. The plate blank obtained has moisture content of 6% to 7%.

In said step (7) of adhering by hot-pressing, the hot-pressing is conducted in a medium temperature and high pressure environment, wherein the temperature is 100 to 150° C., and the pressure is 200 to 260 kilograms/cm². The process of adhering by hot-pressing lasts for 40 to 70 seconds.

In said step (8) of shaping by cold-pressing, the process of shaping by cold-pressing is conducted in an environment wherein the temperature is −10 to 10° C. and the pressure is 200 to 260 kilograms/cm². The process of shaping by cold-pressing lasts for 40 to 70 seconds.

The said adhesive is formaldehyde-free artificial board adhesive.

The merits of this invention are: Any crop straws could be selected as the raw materials; it has a wide scope of application; the pollution caused by burning the straws is reduced, resource re-cycling is achieved. Besides, this invention adopts formaldehyde-free adhesive, making the fiber board obtained safe and environmental.

### DESCRIPTION OF FIGURES

FIG. 1 is the diagrammatic drawing of the defiberating horizontal digester equipment.

FIG. 2 is the diagrammatic drawing of the presses set in tandem.

### REFERENCE

1: electric motor transmission device
2: screw feeder
3: T tube
4: backward-injecting device
5: horizontal digester
6: screw conveyer
7: defiberator
8: No. 1 press
9: No. 2 press
10: No. 3 press

### Embodiments

This invention discloses the manufacture of high-density fiber board made of crop straws with the following steps:
(1) Mashing the straws, and choosing the straws which have the length of 10 mm to 40 mm and moisture content of 20% to 30% as the raw materials;
(2) Sending the raw materials into the digester 5 to digest and soften the straw raw materials;
(3) Sending the raw materials into the defiberator 7, grinding the raw materials to obtain straw fibers;
(4) Sending the straw fibers into the liquid applying system to mix the straw fibers with adhesive, then drying the straw fibers with hot wind;
(5) Continuing paving the straw fibers, then pre-pressing the straw fibers to obtain a plate blank with thickness of 30 mm to 180 mm;
(6) Sending the plate blank into No. 1 hot press 8 to dehydrate the plate blank by hot-pressing;
(7) Sending the plate blank sent from No. 1 hot press 8 into No. 2 hot press 9 to adhere the plate blank by hot-pressing;
(8) Sending the plate blank sent from No. 2 hot press 9 into cold press 10 to shape the plate blank by cold-pressing;
(9) Trimming and sanding the plate blank sent from the cold press 10 to make the fiber board.

In said step (2) of softening the straw raw materials, horizontal digester 5 is adopted. The digester 5 is inclined to the ground with an included angel of 3 to 6°. The digester 5 is injected with water to digest the raw materials, wherein the weight ratio of water to the straws is 1 to 1. The temperature of the steam in the digester 5 is 80 to 160° C. The pressure in the digester 5 is 3 to 6 kilograms/cm². The time that the raw materials pass through the digester 5 is 10 to 20 minutes.

In said step (4) of sending the straws into the liquid applying system, the straw fibers are pushed in the tube by steam force, while adhesive is sprayed. The weight ratio of the adhesive to the straw fibers is 12 to 100. The straw fibers obtained from drying with hot wind have moisture content of 12% to 18%.

In said step (6) of dehydrating by hot-pressing, the hot-pressing is conducted in a high temperature and medium pressure environment, wherein the temperature is 130 to 200° C., and the pressure is 110 to 150 kilograms/cm². The said dehydrating by hot-pressing lasts for 40 to 70 seconds. The plate blank obtained has moisture content of 6% to 7%.

In said step (7) of adhering by hot-pressing, the hot-pressing is conducted in a medium temperature and high pressure environment, wherein the temperature is 100 to 150° C., and the pressure is 200 to 260 kilograms/cm². The process of adhering by hot-pressing lasts for 40 to 70 seconds.

In said step (8) of shaping by cold-pressing, the process of shaping by cold-pressing is conducted in an environment wherein the temperature is −10 to 10° C. and the pressure is 200 to 260 kilograms/cm². The process of shaping by cold-pressing lasts for 40 to 70 seconds.

The said adhesive is formaldehyde-free artificial board adhesive.

The application of the manufacturing method of the fiber board made of crop straws of this invention is explained in reference of the drawings below.

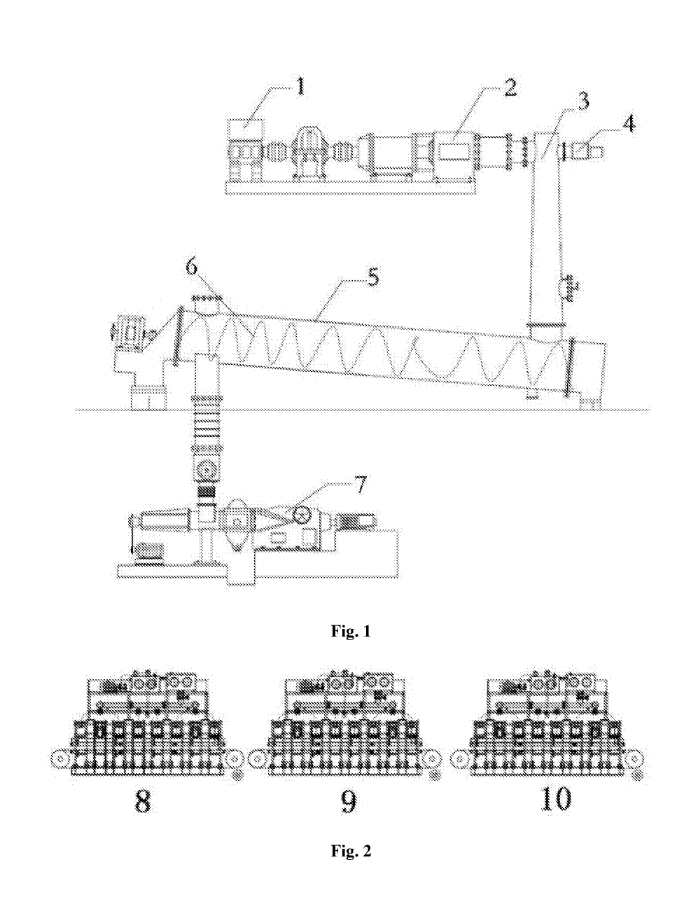

As shown in FIG. 1, the mashed crop straw raw materials are transmitted to the T tube 3 via screw feeder 2 driven by electric motor transmission device. Backward-injecting device is located upside the T tube 3 to inject liquid to the T tube 3. Then the raw materials are conveyed to the horizontal digester 5 via the T tube 3. Previously, the digesters used in the producing process of wood made fiber board are vertically located digester. However, because the weight of straw is lighter than that of wood, bridge has to be set up at the bottom of the digester when adopting vertically located digester. Accordingly, horizontal digester 5 is used in this invention. After entering horizontal digester 5, the straw raw materials are conveyed forward slowly via the screw conveyer 6 in horizontal digester 5. Time spent for the raw materials to pass through the digester 5 is 10 to 20 minutes. Temperature of steam in the digester 5 is 80 to 160° C. Pressure in the digester 5 is 3 to 6 kilograms/cm². The weight ratio of water to straws is 1 to 1. Softened straw raw materials are sent to defiberator 7 to grind. Pressure in the defiberator 7 is 4 to 6 kilograms/cm². Straw fibers are separated.

Straw fibers separated in the defiberator 7 are conveyed forward spirally via the transmission tube by steam force pushing device, while adhesive is sprayed from the walls of the tube. The process of stirring and mixing the adhesive is finished while conveying the straw fibers.

The adhesive selected in this invention is formaldehyde-free artificial board adhesive (CN200910200643.X). This adhesive is made of mixture of two formula liquid, i.e. made of mixture of paraffin emulsion and polyvinyl alcohol mixture, wherein the formula of paraffin emulsion is (percentage by weight):
Paraffin: 32.9%
Ammonia liquor: 6.8%
Oleic acid: 5.48%
Water: 54.82%
   The formula of polyvinyl alcohol mixture is (percentage by weight):
Sugar: 3.66%
Glutinous rice flour: 4.89%
Polyvinyl alcohol: 3.05%
Water: 88.4%

The mixed straw fibers are sent to hot wind with temperature of 100 to 135° C. to dry. This process lasts for 8 to 12 seconds. The dried straw fibers' moisture content is 12% to 18%.

Then the straw fibers are paved to such a density that is needed to make fiber board, and is pre-pressed into a plate blank with thickness of 30 to 180 mm.

As is shown in FIG. 2, this invention adopts the technique arrangement of three presses set in tandem. The plate blank sent into No. 1 hot press is hot-pressed to dehydrate in a high temperature and medium pressure environment, wherein the temperature is 130 to 200° C., and the pressure is 110 to 150 kilograms/cm². The process of dehydrating by hot-pressing lasts for 40 to 70 seconds. The plate blank obtained after hot-pressing has moisture content of 6% to 7%.

The plate blank is sent from No. 1 hot press into No. 2 hot press 9 to be adhered by hot-pressing in a medium temperature and high pressure environment, wherein the temperature is 100 to 150° C., and the pressure is 200 to 260 kilograms/cm². The process of adhering by hot-pressing lasts for 40 to 70 seconds. The optimal temperature to adhere is 120° C. When the plate blank is dehydrated in No. 1 hot press 8, the adhesive is able to completely adhere and fix the straw fibers under the temperature and press environment in No. 2 hot press 9.

Then the plate blank is sent from No. 2 hot press 9 into No. 3 cold press 10. No. 3 press is cold press, wherein the temperature is −10 to 10° C. to shape the plate blank by cold-pressing. While shaping the plate blank, physical character generated from quick cooling is used to further improve the adhesiveness of the plate blank. The said cold press 10 is formed by adding refrigerant into the pipeline of the hot press board of the existed hot press.

After the three presses are set in tandem, each press has the same pressing time, which means production line is formed and productivity is improved. The plate blank is produced into medium or high density fiber board by trimming and sanding, so as to achieve the industrial standard of the medium or high density fiber board ruled by the Chinese government.

1. A method of manufacturing crop straw fiber board, wherein the method comprises:
(1) mashing straws and choosing the straws which have a length of 10 mm to 40 mm and moisture content of 20% to 30% as raw materials;
(2) sending the raw materials into a digester to digest and soften the raw materials;
(3) sending the raw materials into a defiberator to grind the raw materials and obtain straw fibers;
(4) sending the straw fibers into a liquid applying system to mix the straw fibers with an adhesive and drying the straw fibers with hot wind, wherein the adhesive is formaldehyde-free artificial board adhesive;
(5) continuing paving the straw fibers, then pre-pressing the straw fibers to obtain a plate blank with thickness of 30 mm to 180 mm;
(6) sending the plate blank into a first hot press to dehydrate the plate blank by hot pressing;
(7) sending the plate blank sent from the first hot press into a second hot press to adhere the plate blank by hot-pressing;
(8) sending the plate blank from the second hot press into a cold press to shape the plate blank by cold-pressing; and
(9) trimming and sanding the plate blank sent from the cold press to make the fiber board.

2. The method of manufacturing crop straw fiber board according to claim 1, wherein the digester is a horizontal digester that is inclined to the ground with an angle of 3 to 6°, the digester is injected with water to digest the raw materials, a temperature of steam in the digester is 80 to 160° C., a pressure in the digester is 3 to 6 kilograms/cm², and a time that the materials pass through the digester is 10 to 20 minutes.

3. The method of manufacturing crop straw fiber board according to claim 1, the method being characterized in that: in said step (4) of sending the straw fibers into the liquid applying system, the straw fibers are pushed in a tube by steam force while adhesive is sprayed, wherein the straw fibers obtained from drying with hot wind have moisture content of 12% to 18%.

4. The method of manufacturing crop straw fiber board according to claim 1, the method being characterized in that: in said step (6) of dehydrating by hot-pressing, the hot-pressing is conducted in a high temperature and a medium pressure environment, wherein the temperature is 130 to 200° C, the pressure is 110 to 150 kilograms/cm², the said dehydrating by hot-pressing lasts for 40 to 70 seconds, and the plate blank obtained has a moisture content of 6% to 7%.

5. The method of manufacturing crop straw fiber board according to claim 1, the method being characterized in that: in said step (7) of adhering by hot-pressing, the said hot-pressing is conducted in a medium temperature and high pressure environment, wherein the temperature is 100 to 150° C., the pressure is 200 to 260 kilograms/cm², and the adhering by hot-pressing lasts for 40 to 70 seconds.

6. The method of manufacturing crop straw fiber board according to claim 1, the method being characterized in that: in said step (8) of shaping by cold-pressing, the shaping by cold-pressing is conducted in an environment with a temperature of −10 to 10° C. and a pressure of 200 to 260 kilograms/cm², wherein the shaping by cold-pressing lasts for 40 to 70 seconds.

7. (canceled)
